(19) United States
(12) Patent Application Publication
(10) Pub. No.: US 2014/0323119 A1
(43) Pub. Date: Oct. 30, 2014

(54) METHOD OF AND APPARATUS FOR SERVICE COVERAGE MANAGEMENT IN A RADIO COMMUNICATION NETWORK

(71) Applicant: Attila Bader, Paty (HU)

(72) Inventor: Attila Bader, Paty (HU)

(73) Assignee: Telefonaktiebolaget L M Ericsson (PUBL), Stockholm (SE)

(21) Appl. No.: 14/235,181

(22) PCT Filed: Jul. 28, 2011
(86) PCT No.: PCT/EP2011/063031

§ 371 Date: May 12, 2014

(51) Int. Cl. H04W 24/02

(52) U.S. Cl. CPC H04W 24/02
USPC 455/419; 455/560

(57) ABSTRACT

The present invention provides an automatic method, in a management node of a radio communication network, of service coverage management in the radio communication network, in which a radio management function is used for continually managing radio transmissions within the radio communication network and where the operation of the radio management function is determined by at least one control parameter, in which at least one of a radio environment measurement mapping or a performance indicator mapping of the radio communication network is analysed to determine a service coverage mapping of the radio communication network; a new value for at least one control parameter for the radio management function in order is generated to optimise the service coverage of the radio communication network; and the new value for the or each new control parameter for the respective radio management function in the network is distributed.

### FIELD OF THE INVENTION

The present invention relates to a method of and apparatus for service coverage management in a radio communication network. In particular the present invention relates to a method of and apparatus for service coverage management in a radio communication network in which a radio management function is used for continually managing radio transmissions within the radio communication network.

### BACKGROUND

Wide band code division multiple access (WCDMA) networks and 3^{rd} Generation partnership project (3GPP) Long Term Evolution (LTE) networks are two examples of complex multi-service cellular radio networks that are currently being deployed and that provide a variety of services to a large number of users.

These types of networks may implement advanced radio management functions that enable the network resources and service quality delivered to users of the network to be optimized at network level. Examples of such radio management functions are: channel switching; power control; load balancing; use of advanced coding schemes; use of multiple and multi-band antenna systems; active admission control; active handover; capacity management features; and other radio technology functions that optimize the network resources and service quality at network level. Typically the advanced radio management functions may be implemented in base stations or base station controllers.

Generally, in these networks, the number of users served by the network, the network traffic generated by the users and the number of service types available in the network are continually increasing. Therefore, network expansion and the performance monitoring and optimization of the network are of interest to the network operators.

One of the key factors that determines the user experience and performance of a network is the service coverage provided by the network. In its simplest definition the coverage of a cellular radio network is the area in which the signal of the base stations is good enough to be able to provide network services to a user terminal. However, the concept of the coverage of a cellular radio network is more complex and may be characterized by many performance indicators. For example, the 3^{rd} Generation Partnership Project (3GPP) has defined categories of performance indicators to characterize the service coverage in a cellular radio network.

Currently networks use performance monitoring and optimization to ensure the service quality of the network. The main goals of the network optimization process are to improve the quality of services to the users and/or to use more efficiently the network equipment and the radio resources, in order to reduce the operational costs (OPEX) and investment costs (CAPEX) of the network operator. One of the main optimization process tasks is to improve the coverage provided by the radio network.

However, the service coverage provided by the radio network is not constant, but instead varies over time. In particular, the advanced radio management functions indicated above directly and dynamically influence the service coverage provided by the radio network. In other networks, for example in wide band code division multiple access (WCDMA) networks, the cell size and service coverage strongly depends on the traffic and therefore the service coverage can vary significantly over time, in particular between peak and off-peak hours. In addition, the service coverage of the radio network changes significantly when significant changes are made to the radio network, for example when a new cell is added to the radio network.

Current coverage optimization processes are often based on extensive drive tests that are time consuming and expensive or may not be possible, for example in situations such as dense urban or pedestrian areas. In addition, generally an optimization process is carried out for high level performance indicators, which can lead to network instability or suboptimum system operation for unmonitored performance indicators. In addition, optimization is carried out at cell level only, which can hide small coverage holes and can lead to overreaction of the optimization.

The invention seeks to at least ameliorate the disadvantages of the prior art and to provide a method and apparatus for service coverage management in a radio communication network.

### SUMMARY

In accordance with one aspect of the invention there is provided a an automatic method, in a management node of a radio communication network, of service coverage management in the radio communication network, in which a radio management function is used for continually managing radio transmissions within the radio communication network and where the operation of the radio management function is determined by at least one control parameter. In a first step, at least one of a radio environment measurement mapping or a performance indicator mapping of the radio communication network is analysed to determine a service coverage mapping of the radio communication network. In a second step, a new value for the at least one control parameter for the radio management function is generated to optimise the service coverage of the radio communication network. In a third step the new value for the or each control parameter for the respective radio management function in the network is distributed.

In some embodiments, the control parameter is used by a radio management function in determining a radio parameter affecting radio transmissions within the radio communication network.

In some embodiments the performance indicator mapping of the radio communication network is used in the step of analysing.

In some embodiments the method also comprises a step of operating with the optimised control parameters for a control parameter wait period. It is determined whether the new value of the at least one control parameter has improved the network coverage. In response to an improvement, the or each trial control parameter is confirmed as the corresponding control parameter for the radio communication network.

In some embodiments the step of determining whether the new value of the at least one control parameter has improved the network coverage comprises a first step of comparing radio measurements in the radio communication network operating using the trial value for the at least one control parameter with prior radio measurements. In a second step, performance indicators in the radio communication network operating using trial value for the at least one control parameter are compared with prior performance indicators.

In some embodiments the step of comparing radio measurements comprises a first step of forming a radio measurement mapping from received network radio measurements and position data associated with the radio measurements in the radio communication network operating using the trial network parameter. In a second step the radio measurement mapping is compared with a prior radio measurement mapping.

In some embodiments the step of comparing performance indicators comprises a first step of forming a performance indicator mapping from received performance indicators and position data associated with the performance indicators in a radio communication network operating using the trial network parameter. In a second step the performance indicator mapping is compared with a prior performance indicator mapping.

In some embodiments the control parameter wait period is of the order of a few minutes to an hour.

In some embodiments in response to a negative determination in the step of determining optimisation of at least one configuration parameter of the radio communication network is requested.

In some embodiments the step of analysing at least one of a radio environment measurement mapping or a performance indicator mapping of the radio communication network to determine a service coverage mapping of the radio communication network is carried out in response to the optimisation of at least one configuration parameter of the radio communication network.

In some embodiments the at least one configuration parameter relates to one or more of: antenna height; antenna type; antenna direction; frequency band; site location of base stations of the radio network.

In accordance with a second aspect of the invention there is provided a management node of a radio communication network, in which radio communication network a radio management function is used for continually managing radio transmissions within the radio communication network and where the operation of the radio management function is determined by at least one control parameter. The management node comprises a parameter optimisation function for analysing at least one of a radio environment measurement mapping or a performance indicator mapping of the radio communication network to determine a service coverage mapping of the radio communication network and generating a new value for the at least one control parameter for the radio management function in order to optimise the service coverage of the radio communication network. The management node also comprises a configuration service for distributing the new value for the or each control parameter for the respective radio management function in the network.

In some embodiments the at least one control parameter is a control parameter for use by the radio management function in determining a radio parameter affecting the radio transmissions within the radio communication network.

In some embodiments the parameter optimisation function includes a correlation function arranged to receive position information and performance indicator measurements and to generate a performance indicator mapping of the radio communication network.

In some embodiments the management node comprises a compare function, the compare function being arranged to receive and compare the target performance indicator values and the performance indicator mapping of the radio communication network.

In some embodiments the correlation function is also arranged to receive radio environment data and to generate a radio environment mapping of the radio communication network.

In some embodiments the management node comprises a compare function, the compare function being arranged to receive and compare the target radio environment value and the radio environment mapping of the radio communication network.

In some embodiments the management node comprises a logic function arranged to receive comparison information and operable to generate a new value for the at least one control parameter for the radio management function in order to optimise the service coverage of the radio communication network.

In some embodiments the management node comprises a scheduler coupled to the parameter optimisation function and arranged to initiate an optimisation process after the elapse of a control parameter wait period.

In some embodiments the control parameter wait period is of the order of a few minutes to an hour.

### DESCRIPTION OF FIGURES

FIG. 1 is a schematic diagram of radio communication system network in accordance with an exemplary embodiment;

FIG. 2 is a schematic diagram of a first embodiment of a control parameter optimisation function in the radio communication network shown in FIG. 1;

FIG. 3 is a schematic diagram of a second embodiment of a control parameter optimisation function in the radio communication network shown in FIG. 1;

FIG. 4 is a schematic diagram of a first embodiment of a configuration parameter optimisation function in the radio communication network shown in FIG. 1;

FIG. 5 is a schematic diagram of a second embodiment of a configuration parameter optimisation function in the radio communication network shown in FIG. 1;

FIG. 6 is a flow chart showing a method of optimising control parameters in the radio communication network shown in FIG. 1 in accordance with an exemplary embodiment;

FIG. 7 is a flow chart showing a method of optimising configuration parameters in the radio communication network shown in FIG. 1 in accordance with an exemplary embodiment; and

FIG. 8 is a flow chart showing a combined method of optimising control parameters and configuration parameters in the radio communication network shown in FIG. 1 in accordance with an exemplary embodiment.

### DETAILED DESCRIPTION

In embodiments of the invention, control parameters for radio management functions operating within a radio communication network are optimised automatically in a network management node in response to an analysis of radio environment measurements and/or performance indicators of the radio communication network.

In embodiments of the invention, the radio management functions use the control parameters when determining radio parameters affecting radio transmissions in the radio communication network. Since the control parameters of the radio management functions are optimised in response to an analysis of the performance indicators and/or the radio environment, the interaction between the network level and network management level optimization functions is handled consistently.

In the description of embodiments of the present invention reference is made to the radio management functions that may operate in a radio communication network and to the control parameters for the radio management functions. Typically a control parameter for a radio management function is used by the radio management function in determining a radio parameter affecting the radio transmission. For example, in some arrangements a control parameter may define the maximum value or minimum value that may be selected for a radio parameter by the radio management function.

A first example of a radio management function in a radio network is an advanced power management network function. Advanced power management network functions continually adjust the transmitted power between certain limits in response to changing radio conditions and according to the transmission needs during a session. Control parameters for an advanced power management network function that may be used during optimization of the network coverage might be control parameters determining the boundary conditions of the power management function, such as the minimum value limit and maximum value limit of the transmit power as well as any offset values and any other parameters determining the actual transmitted power.

Thus, in cells where the analysis of the performance indicators and/or the radio environment shows that the coverage is good, the control parameter limiting the transmit power may be decreased so as to reduce the maximum transmit power that can be selected by the power management function. Equally, in the cells where the analysis of the performance indicators and/or the radio environment shows that the coverage is not good, the control parameter limiting the transmit power may be increased so as to increase the maximum transmit power that can be selected by the power management function.

A second example of a radio management function in a radio communication network is an automatic radio channel switching function, for example as has been implemented in wideband code division multiple access (WCDMA) radio networks. The automatic radio channel switching function dynamically allocates the radio channels to the packet switched sessions according to the need of the traffic and the radio conditions in order to optimize the use of the radio resources. For example if the traffic does not require a dedicated channel, the session is switched to a common channel in order to save resources. The switching conditions also depend on the actual radio environments. For example, traffic is switched to a lower bit rate channel when radio conditions are bad. If it is possible the higher bit rate channel is used. Since the different radio channels have different radio requirements the coverage can also be different for different radio channels.

The switching thresholds, timing parameters, bandwidth thresholds, and enabling/disabling switching between different channels are all control parameters of a radio channel switching function that influence the coverage provided by the radio communication network and that may be optimized in embodiments of this invention. Where the analysis of the performance indicators and/or the radio environment shows that the coverage is not good, the switching thresholds, timing and bandwidth parameters for channels lower coverage may be increased, and switching thresholds for better coverage channels may be decreased. It is also possible to disable transitions between specific channels for coverage reasons.

A third example of a radio management function in a radio network is an automatic load sharing function. A load sharing function distributes traffic between multiple frequency bands or different radio networks. Different frequency bands and radio networks may have different coverage in the same area, and therefore the overall coverage can be improved by optimizing the control parameters of the transition between different networks or frequency bands.

The control parameters for a load sharing radio management function that may be used during optimization of the network coverage in embodiments of the invention might be: triggering thresholds; margins; load sharing fractions; and enable/disable transition options or other triggering between different networks or frequency bands. The optimization of control parameters for inter-frequency and inter radio technology handover function can improve coverage significantly.

For example, where the analysis of the performance indicators and/or the radio environment shows that the coverage for one of the frequencies is not good and there is good coverage for other frequencies, the triggering threshold for a transfer to the frequency with good coverage may be decreased, and thus the load share of that channel increased. In some arrangements it might be that transition to a network or frequency band with low coverage in that area may be disabled.

A fourth example of a radio management function in a radio communication network is a higher order coding scheme function. Radio communication networks may allow the use of higher order coding schemes in good radio environments. For example, 64-QAM (Quadrature Amplitude Modulation) and 128-QAM (Quadrature Amplitude Modulation) coding schemes are permitted in a 3rd Generation Partnership Project Long Term Evolution (3GPP LTE) radio network.

Although the use of higher order coding schemes increases the transport capacity, when higher coding schemes are used the coverage is more limited than for lower rates in the same radio conditions. Control parameters for this radio management function that may be used during optimization of the network coverage in embodiments of the invention might be: control parameter enabling/disabling the use of higher order coding schemes; and control parameters defining transition threshold values between the coding schemes.

A fifth example of a radio management function in a radio communication network is the use of multiple antennas and multiple antenna related features. Multiple antennas can be used to increase the coverage by providing spatial diversity and multiplexing of downlink traffic, as well as for beam forming. Control parameters for this radio management function that may be used during optimization of the network coverage in embodiments of the invention might be: the enabling/disabling of multiple antenna features; and parameters that control the switching between these operation modes.

Further examples of radio management functions such as radio network admission management functions and congestion control management functions also influence coverage. Therefore any control parameters used by radio management functions for controlling admission or congestion in the radio network may be optimized for coverage also in accordance with embodiments of the invention.

As described above, the control parameters of advanced radio management functions of the communication network are soft parameters that are optimized in a soft control parameter optimization loop in accordance with embodiments of the invention to adapt the network operation smoothly to traffic and radio environment changes.

In some embodiments a soft control parameter optimization loop may be automatically carried out at suitable intervals, typically of the order of every hour. The interval between executions of the soft control parameter optimization loop may be selected by a skilled person to ensure that the control parameters are optimized sufficiently frequently to take account of expected network coverage changes over time.

In accordance with some embodiments hard configuration parameters are optimized in a hard configuration parameter optimization loop to adapt the network operation to traffic and radio environment changes. Configuration parameters may be optimized may include: antenna height at the base station; antenna type at the base station; antenna directions at the base station; frequency bands allocated to the base station; and base station site location.

In some embodiments a hard configuration parameter optimization loop may be automatically carried out at suitable intervals, typically of the order of a few hours to a day or so in some embodiments. In some embodiments, a soft control parameter optimization loop may be used to optimize the network by changing soft parameters automatically after a change in hard configuration parameter.

As will be appreciated, the invention may be implemented using a number of different technologies. In embodiments of the invention, radio measurements for radio environment monitoring made by the user equipment and/or the base stations in accordance with 3rd Generation Partnership Project 3GPP standards are used in the automatic optimization of the control parameters, so no additional probes or measurement equipment or drive tests are necessary to gather information about the radio environment.

In a wideband code division multiple access (WCDMA) radio network, examples of radio environment values from a user equipment that may be used in embodiments of the invention are: CPICH RSCP (Common Pilot Channel Received Code Power) measurements; RSSI (Received Signal Strength Indicator) values; CPICH Ec/No (Common Pilot Channel chip signal to noise ratio) values; Transport channel BLER (Block error rate) measurements; and the user equipment (UE) transmitted power values.

In a wideband code division multiple access (WCDMA) radio network, examples of radio environment values from a base station that may be used in embodiments of the invention are: Received total wide band power values; Signal to Interference Ratio (SIR) values; Transmitted carrier power values; Transmitted code power values; Transport channel BER (Bit Error Rate) values; Physical channel BER (bit error rate) values; Round trip time values.

Further information on the wideband code division multiple access (WCDMA) radio parameters can be found in 3rd Generation Partnership Project Technical Specification Group Radio Access Network Physical layer Measurements (FDD) 3GPP TS 25.215 V9.2.0 (2010-03).

In a 3rd Generation Partnership Project Long Term Evolution (LTE) radio network, examples of radio environment values that may be used in embodiments of the invention are: Reference Signal Received Power (RSRP) value; Reference Signal Received Quality (RSRQ) value; Reference signal time difference (RSTD) value; User equipment receive-transmit (UE Rx−Tx) time difference value; downlink receive-transmit (DL Rx−Tx) power value; Received Interference Power value; Thermal noise power value; Timing advance (TADV) value; eNB Rx−Tx time difference value.

Further information on the Long Term Evolution (LTE) radio parameters can be found in 3rd Generation Partnership Project Technical Specification Group Radio Access Network Evolved Universal Terrestrial Radio Access (E-UTRA) Physical layer Measurements (Release 10) 3GPP TS 36.214 V10.0.0 (2010-12) Technical Specification.

In wideband code division multiple access (WCDMA) networks implementing embodiments of the invention the CPICH RSCP (Common Pilot Channel Received Code Power) value, CPICH Ec/No (Common Pilot Channel chip signal to noise ratio) value and Received total wide band power values may typically be used as radio environment measurements. In case of 3rd Generation Partnership Project Long Term Evolution (LTE) networks implementing embodiments of the invention, the Reference Signal Received Power (RSRP) values and Reference Signal Received Quality (RSRQ) values are typically used as radio environment values.

In some embodiments more parameters from the above list can be used as radio environment values either alone or in combination with each other.

The coverage of the network can be obtained directly by measuring the signal level and the signal to noise ratio (i.e. interference level). The signal and interference levels influence the most important key performance indicators (KPIs). Therefore, the coverage of the network may be measured using a number of performance indicators, as will be known by a skilled person.

The 3^{rd} Generation Partnership Project (3GPP) has defined the following categories of performance indicators to characterize the service coverage in a cellular radio network:

A first category of performance indicators relates to the accessibility of the radio network. This category includes performance indicators that characterize the availability of the service from the user point of view, or more precisely the success rate of the call establishment. It is noted that the call setup can fail in different phases of the call setup and for different reasons: for example lack of resources, bad radio conditions, system failure. Accessibility performance indicators may include: number of access attempts and a success rate/fail rate of accessing the requested radio resources and radio channels for each of the service types.

A second category of performance indicators relates to the maintainability or retainability of the radio network connection. This category includes performance indicators that characterize the continuity of the service once the service connection is set up. These performance indicators may include for example the drop rate, i.e. the number of sessions that are terminated during the service in a given time period. The cause of the service termination is usually also reported. Maintainability performance indicators may include: the drop rate due to pure radio environment or radio related changes, preferably measured per service type.

A third category of performance indicators relates to the integrity of the radio network connection with the user equipment. This category of performance indicators includes all the indicators relating to the quality of the service during a service session. This category may include indicators that directly influence the quality of service experienced by the user, such as for example: delay, packet loss, block error rate, and the retransmission rate. Integrity performance indicators may include: block or frame error rate for circuit switched (CS) services; throughput parameters for packet switched services (PS services); packet level quality of service (QoS) parameters such as packet loss, delay, jitter may also be monitored.

A fourth category of performance indicators relates to the mobility of the user between cells in the cellular network. This category of performance indicators may include all indicators that are related to the handover performance between the cells of a cellular network, as well as performance indicators related to the handover performance between networks of different network types. Performance indicators in this category are important because seamless handover is a key characteristic of a cellular network with a good coverage and a good level of service. Mobility performance indicators may include: number of handover attempts, handover success rate and handover failure rates per service types. In many radio networks monitoring of mobility performance indicators is a sensitive method to characterize coverage, since coverage is low usually at cell borders, where handover is the most frequent.

A fifth category of performance indicators relates to the system related indicators such as utilization indicators that relate to the actual service usage or to future service usage. These indicators are very important from a network planning and optimization point of view. Utilization performance indicators may include: traffic volume (Erlang, kbps) and all available system parameters characterizing the load and resource usage, comparing to their maximum or available values. Utilization monitoring is needed to ensure that changing the radio parameters does not lead to any system overload in a certain cells or areas.

Embodiments of the invention will now be explained in more detail with reference to the accompanying drawings.

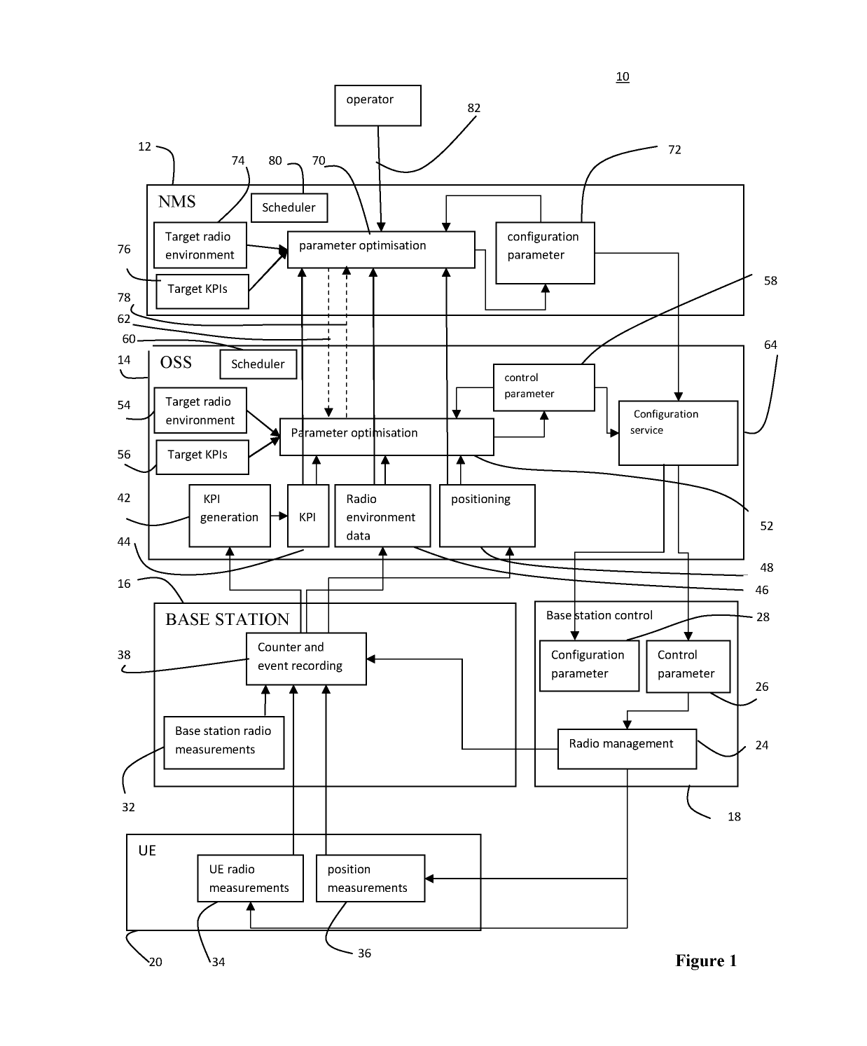

FIG. 1 is a schematic diagram of key entities in a radio communication network 10 in accordance with an exemplary embodiment.

In the exemplary radio communication network 10 shown in FIG. 1, a network management system NMS 12 is shown, which performs a network management function within the radio communication network 10. The radio communication network 10 also has an Operation Support System OSS 14 which fulfils an operations management role within the radio communications network 10. A base station 16 is controlled by a corresponding base station controller 18 to communicate with user equipment UE 20 over a radio interface.

Embodiments of the invention may be implemented in radio communication networks 10 using a number of different technologies, and the embodiment described with reference to FIG. 1 is not intended to be limited to the use of any particular technology. The general operation and functions of the network management system NMS 12, Operation Support System OSS 14, base station 16, base station controller 18 and user equipment UE 20 will be known to a skilled person familiar with radio communication networks and so will not be explained in more detail.

The base station controller 18 is provided with at least one radio management function 24 having at least one control parameter 26. The radio management function 24 of base station controller 18 uses the control parameter 26 to form radio parameters to manage radio transmissions within the radio communication network and the radio management function 24 is coupled to the base station 16 to control operation of the base station 16 in accordance with the radio parameters.

As will be explained in more detail in the following description, in embodiments of the invention the control parameter 26 is determined as a result of a parameter optimisation The origin of the control parameter 26 and its transmission to the base station controller 18 will be explained in more detail in the following description.

In addition, the base station 18 is provided with at least one configuration parameter 28. As discussed earlier, in some embodiments the configuration parameter 28 may determine the radio plan and in particular in embodiments may relate to the antenna height, type or direction, or the frequency band being used by the base station 16 controlled by the base station controller 18. The origin of the configuration parameter 28 and its transmission to the base station controller 18 will be explained in more detail in the following description.

The base station controller 18 is coupled to the base station 16 and controls the operation of the base station 16 in accordance with radio parameters (not shown) that have been determined using the control parameter 26, and the one or more configuration parameter 28.

During operation of the user equipment UE 20 in the radio communication network 10, the base station will make various base station radio measurements 32. In addition, the user equipment 20 makes UE radio measurements 34 as well as position measurements 36.

The base station radio measurements 32, the user equipment radio measurements 34 and the position measurements 36 are collected by a counter and event recorder 38 in the base station 16. The operation service support OSS 14 is coupled to the counter and event recorder 38 of each of the base stations 16 covered by the operation service support OSS 14 to receive the radio measurements 32, 34 and the position measurements 38.

The Operation service support OSS 14 is provided with a performance indicator generation function 42 that is coupled to the counter and event recorder 38 of the base stations to receive base station radio measurements 32 and user equipment radio measurements 34 and to calculate performance indicators 44. The performance indicators 44 may be selected from the performance indicators discussed above, or any other performance indicators as seems useful to a skilled person. In addition, the radio environment data 46 and positioning data 48 are also supplied to the operation service support OSS 14. In some embodiments the performance indicators 44, the radio environment data 46 and the positioning data 48 may be aggregated or combined.

In embodiments of the invention the operation service support OSS 14 is provided with a control parameter optimisation element 52 that in the exemplary embodiment is coupled to receive performance indicators 44, radio environment data 46 and positioning information 48 in addition to a previous control parameter value 58 stored in the operation service support OSS 14. In addition, in the exemplary embodiment the control parameter optimisation element 52 is coupled to receive target radio environment values 54 and target performance indicator values 56.

In accordance with the exemplary embodiment, the control parameter optimisation element 52 is operable to optimise one or more control parameters 58 stored in the operation service support OSS 14 for one or more radio management function 24.

The operation service support OSS 14 is provided with a scheduler 60 which is arranged to initiate control parameter optimisation by the parameter optimisation element 52 after the elapse of a time period. Typically, in embodiments of the invention, the time period associated with the determination of the control parameter is shorter than the time period associated with the determination of the configuration parameter, and might typically be of the order of a few minutes to a few hours.

In addition, in some embodiments the parameter optimisation element 52 is coupled to the corresponding configuration parameter optimisation element in the network management system to receive an initiation message 62 from the corresponding configuration parameter optimisation element in the network management system, as will be explained in the following description.

Finally, in the exemplary embodiment a managed object approach is taken in which attributes of a network node, such as control parameters for radio management function, are stored as managed objects, and a configuration service 64 is provided to transfer control parameter values 58 stored in the operation service support OSS 14 to control parameter values 26 stored in the base station controller 18.

In embodiments of the invention the network management system NMS 12 is provided with a configuration parameter optimisation element 70 that in the exemplary embodiment is coupled to receive performance indicators 44, radio environment data 46 and positioning information 48 in addition to a previous configuration parameter value 72 stored in the network management system NMS 12. In addition, in the exemplary embodiment the control parameter optimisation element 52 is coupled to receive target radio environment values 74 and target performance indicator values 76.

In accordance with the exemplary embodiment, the configuration parameter optimisation element 70 is operable to optimise one or more configuration parameters 72 stored in the network management system NMS 12 for one or more radio management function 24.

The network management system NMS 12 is provided with a scheduler 80 which is arranged to initiate control parameter optimisation by the parameter optimisation element 52 after the elapse of a time period. Typically, in embodiments of the invention, the time period associated with the determination of the configuration parameter is longer that the time period associated with the determination of the control parameter, and might typically be of the order of a few hours to a day.

In addition, in some embodiments the parameter optimisation element 70 is coupled to the corresponding configuration parameter optimisation element 52 operation system support OSS 14 to receive an initiation message 70 from the corresponding configuration parameter optimisation element in the network management system, as will be explained in the following description.

Finally, in the exemplary embodiment a managed object approach is taken in which attributes of a network node, such as configuration parameters for radio management function, are stored as managed objects, and a configuration service 64 is provided to transfer configuration parameter values 72 stored in the network management system NMS 12 to configuration parameter values 28 stored in the base station controller 18.

In some methods of operation, operator input 82 is available for the operation of the configuration parameter optimisation function 70, so that changes to the configuration parameters, which generally alter the cell plan and therefore have a major effect on the communication network 10 are not made automatically, but only after operator input.

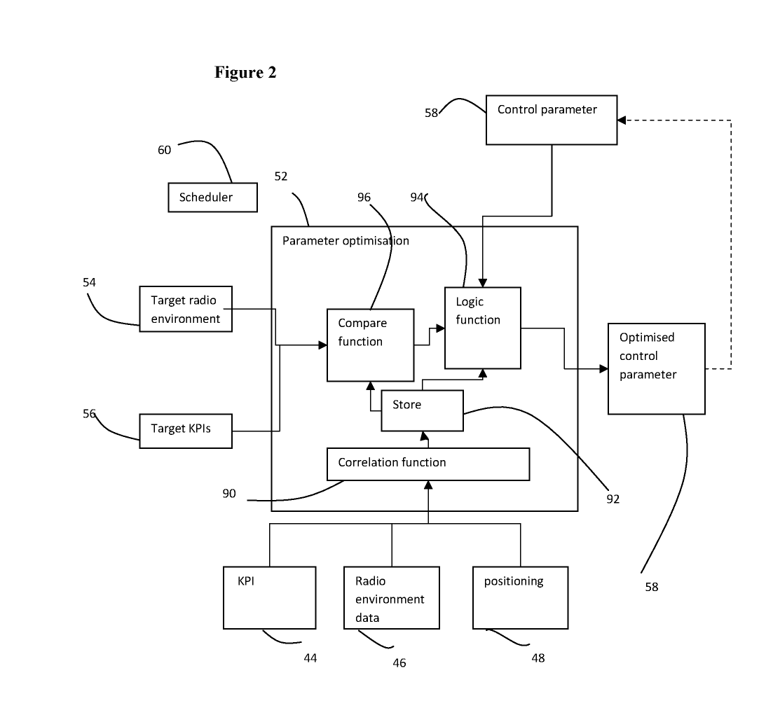

FIG. 2 is a schematic diagram of a first embodiment of a control parameter optimisation function 52 in the operation service support OSS 14 of the radio communication network10 shown in FIG. 1. Elements in FIG. 2 having the same or similar function as elements in FIG. 1 have been given the same reference numerals, and will not be explained further.

The parameter optimisation element 52 is provided with the following elements:
a correlation function unit 90 coupled to receive the performance indicators 44, the radio environment data 46 and the positioning data 48;
a store 92, which may be implemented for example as memory, a file or a database, coupled to store receive and store the performance indicators 44, the radio environment data 46 and the positioning data 48 from the current and from previous instances of a determinations of the control parameter 58;
a comparison unit 96 coupled to the store 92 and to the target radio environment values 54 and to the target performance indicators 56 to compare present and target performance indicators KPI and radio environment data; and
a logic unit 98, coupled to the comparison unit 96, implementing a method of determine whether any optimisation of the control parameter is required based on the input from correlation function unit 90.

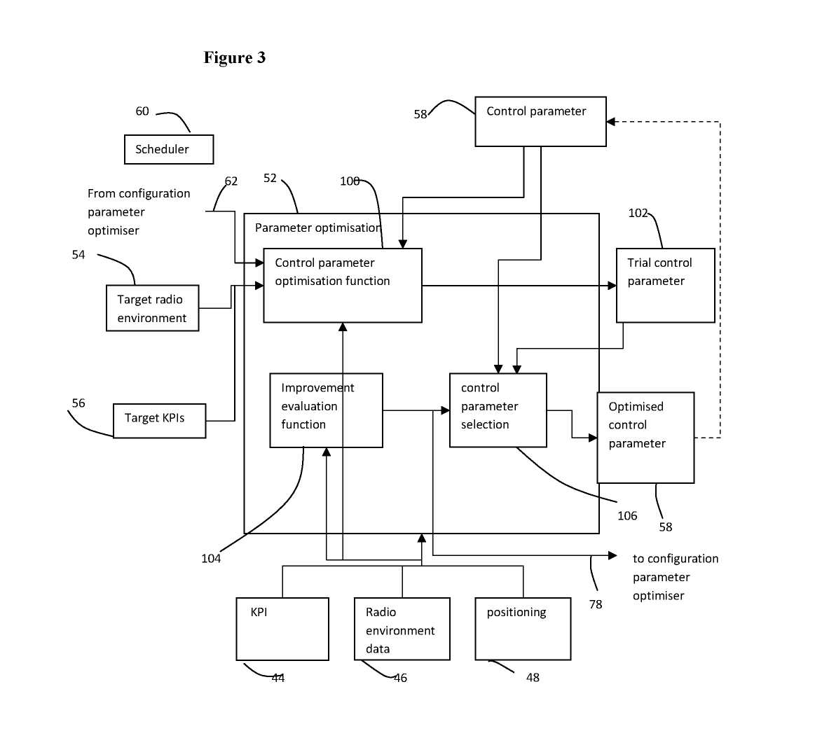

FIG. 3 is a schematic diagram of a second embodiment of a control parameter optimisation function in the radio communication network shown in FIG. 1. Again, elements in FIG. 3 having the same or similar function as elements in previous Figures have been given the same reference numerals, and will not be explained further.

This embodiment is used in situations in which a trial control parameter 102 is initially produced by the control parameter optimisation function 100 as described above with reference to FIG. 2. The operation of the network with the trial parameter is monitored to determine whether the radio environment measurements and the performance indicators are both improved by the use of the trial parameter 102.

Thus an improvement evaluation function 104 is provided that compares the previous radio environment measurements 46 and performance indicators 44 with radio environment measurements and performance indicators during operation with a trial control parameter, and determines whether the control parameter should be the trial parameter 102 or whether the existing control parameter 58 should be maintained depending on whether there is an improvement in both the radio environment measurements and in the performance indicators when the trial control parameter is used.

The evaluation result from the improvement evaluation function 104 is provided to a control parameter selection unit 106. The control parameter selection unit 106 is coupled to receive both the control parameter 58 and the trial control parameter 102, and to output one of the control parameter 58 and the trial control parameter 102 as the optimised control parameter 58 depending on the output of the improvement evaluation function 104.

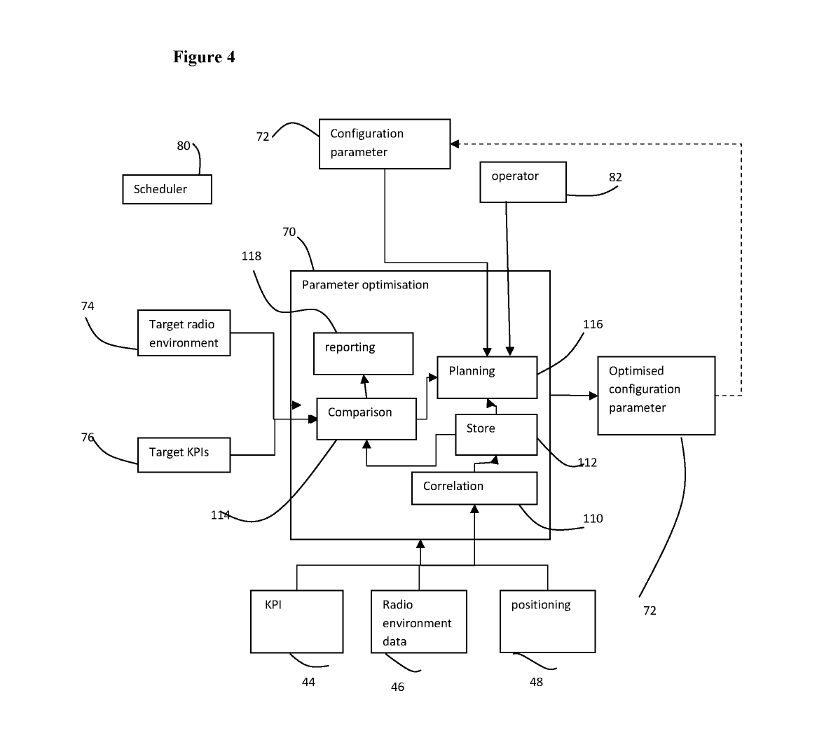

FIG. 4 is a schematic diagram of a first embodiment of a configuration parameter optimisation function in the radio communication network shown in FIG. 1. Again, elements in FIG. 4 having the same or similar function as elements in previous Figures have been given the same reference numerals, and will not be explained further.

The parameter optimisation element 70 is provided with the following elements:
a correlation function 110 coupled to receive the performance indicators 44, the radio environment data 46 and the positioning data 48 and to correlate the input to form a performance mapping of the radio communication system;
a store 112, which may be implemented for example as memory, a file or a database, coupled to receive and store the performance indicators 44, the radio environment data 46 and the positioning data 48 from the current and from previous instances of a determinations of the configuration parameter 58;
comparison unit 114 coupled to the store 92 and to the target radio environment values 54 and to the target performance indicators 56 to compare present and target KPI and radio environment data; and
a planning/optimization function 116 coupled to receive input 82 from an operator, the comparison unit 114, implementing a method of determining whether any optimisation of the control parameter is required based on the input from correlation function unit 110; and a reporting function, coupled to Reporting function (for reporting coverage holes).

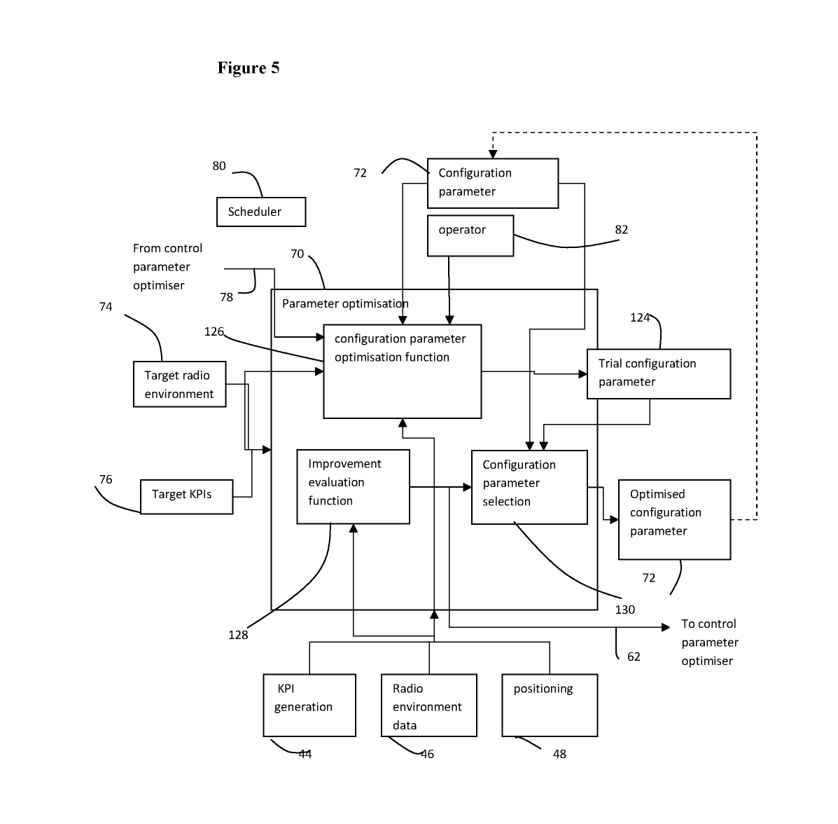

FIG. 5 is a schematic diagram of a second embodiment of a configuration parameter optimisation function in the radio communication network shown in FIG. 1. Again, elements in FIG. 5 having the same or similar function as elements in previous Figures have been given the same reference numerals, and will not be explained further.

This embodiment is used in situations in which a trial configuration parameter 124 is initially produced by the configuration parameter optimisation function 126 as described above with reference to FIG. 2. The operation of the network with the trial parameter is monitored to determine whether the radio environment measurements and the performance indicators are both improved by the use of the trial parameter 124.

Thus an improvement evaluation function 128 is provided that compares the previous radio environment measurements 46 and performance indicators 44 with radio environment measurements and performance indicators during operation with a trial configuration parameter 124, and determines whether the trial configuration parameter 124 should be the optimised configuration parameter or whether the existing control parameter 72 should be maintained depending on whether there is an improvement in both the radio environment measurements and in the performance indicators.

The evaluation result from the improvement evaluation function 128 is provided to a configuration parameter selection unit 130. The configuration parameter selection unit 130 is coupled to receive both the configuration parameter 72 and the trial configuration parameter 124, and to output one of the configuration parameter 72 and the trial configuration parameter 124 as the optimised control parameter depending on the output of the improvement evaluation function 128.

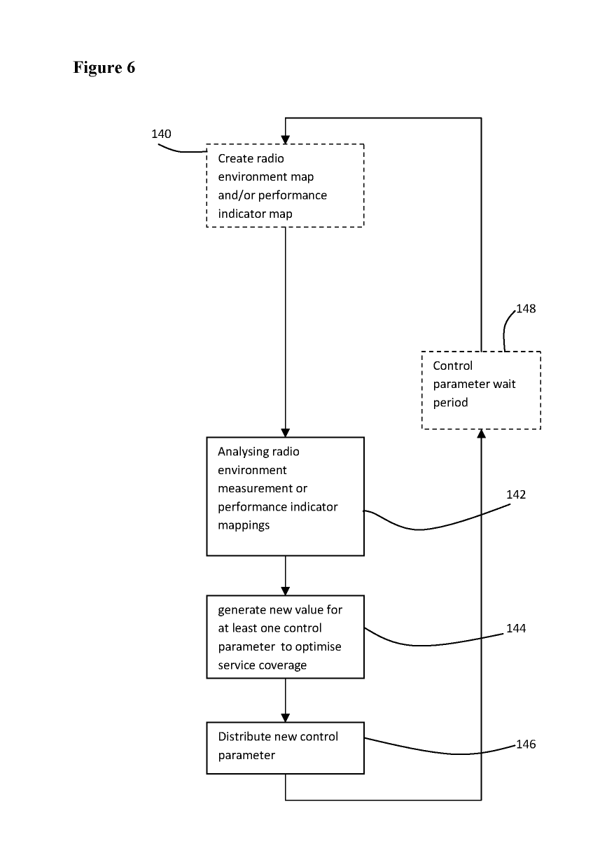

FIG. 6 is a flow chart showing a method of optimising control parameters in the radio communication network shown in FIG. 1 in accordance with an exemplary embodiment.

In a first step 140, a radio environment map and/or a performance indicator map is created from the performance indicators 44, radio environment measurements 46 and positioning information 48. The mapping may be created from performance indicators 44 and/or radio environment measurements 46 in different embodiments. In addition, since in some embodiments this step may be carried out elsewhere, the step is therefore shown in dashed lines.

In a second step 142 the radio environment measurement or performance indicator mappings are analysed.

In a third step 144 control parameters are optimised to generate a new value for at least one control parameter. In one embodiment of the invention this may be achieved by identifying cells and areas where radio coverage and performance indicators are below the targets based on radio and performance indicator measurements and positioning data. The current performance indicators, measurement data, and the actual control parameter sets for each cells are then stored. A new control parameter is set for each cells and neighbouring cells for example where the performance indicators are below the targets.

In a fourth step 146 the new values of the control parameters are distributed.

In step 148, which may be omitted in some embodiments, a control parameter wait period is observed. The control parameter optimisation might typically be repeated after a relatively short period of time, for example in the order of between a few minutes to a few hours.

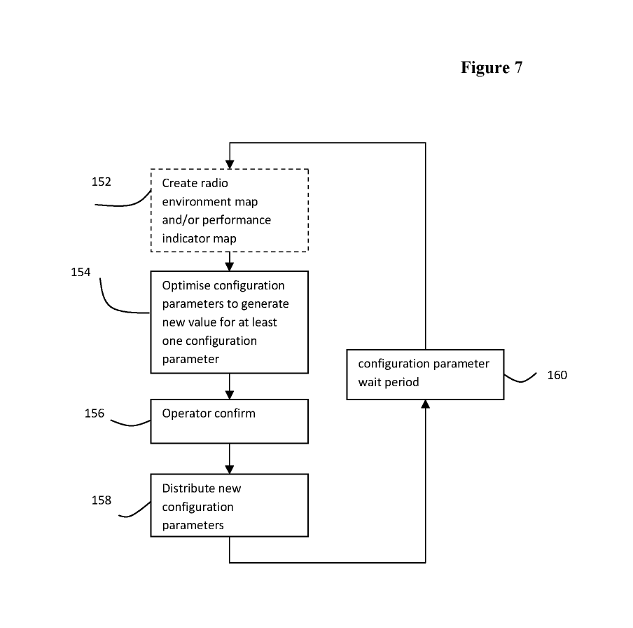

FIG. 7 is a flow chart showing a method of optimising configuration parameters in the radio communication network shown in FIG. 1 in accordance with an exemplary embodiment.

In a first step 152, a radio environment map and/or a performance indicator map is created from the performance indicators 44, radio environment measurements 46 and positioning information 48. The mapping may be created from performance indicators 44 and/or radio environment measurements 46 in different embodiments. In addition, since in some embodiments this step may be carried out elsewhere, the step is therefore shown in dashed lines.

In a second step 154 the configuration parameters are optimised to generate a new value for at least one configuration parameter.

In one embodiment this may be achieved by identifying cells and areas where radio coverage and performance indicators are below the targets for radio and performance indicators measurements and positioning. The current performance indicators, radio environment measurement data, and the actual configuration parameters sets for each cell can be compared with the previous performance indicators, radio environment measurement data, and actual configuration parameters sets for each cell. If the performance indicators are not improved a hole in the radio network coverage can be reported. Radio network cell planning algorithms can determine the new configuration parameter set for each cell and neighbouring cells where performance indicators are below the targets.

In a step 156 the operator may confirm whether the new configuration parameter is approved and operating correctly.

In step 158 the new configuration parameters are distributed if they have been approved by the operator in step 156.

In step 160, which may be omitted in some embodiments, a configuration parameter wait period is observed. The configuration parameter optimisation might typically be repeated after a relatively long period of time, for example in the order of between a few hours to a few days.

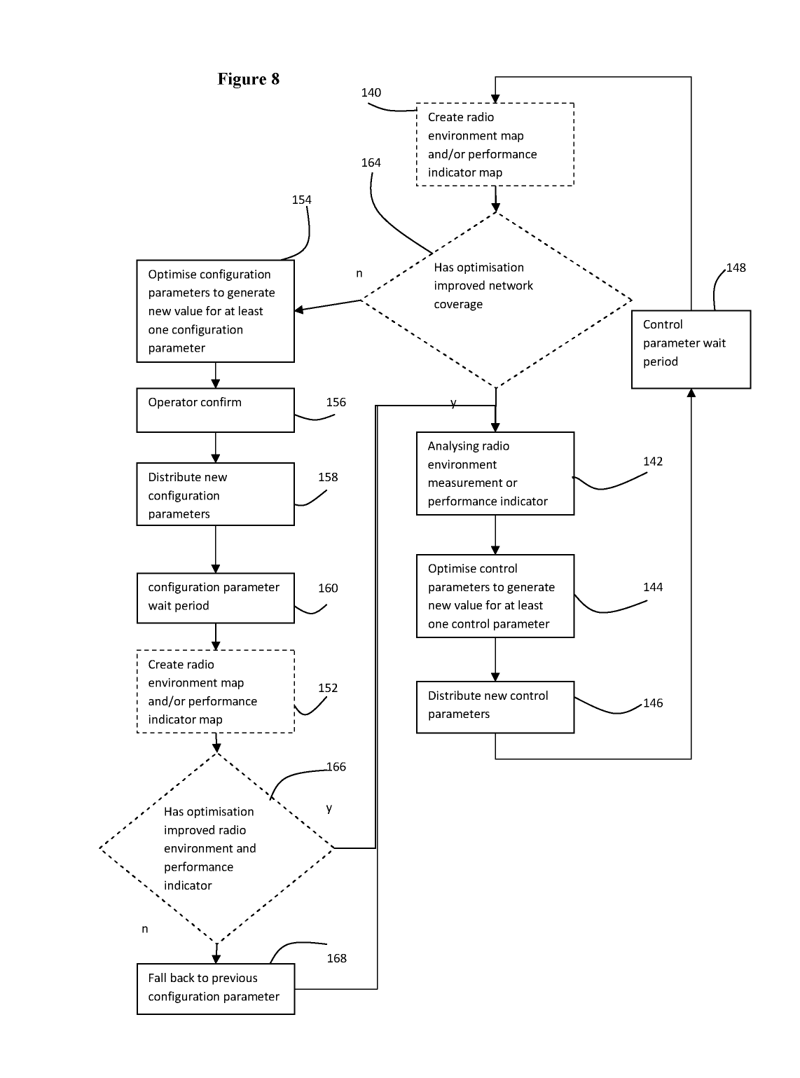

FIG. 8 is a flow chart showing a combined method of optimising control parameters and configuration parameters in the radio communication network shown in FIG. 1 in accordance with an exemplary embodiment. This flow chart illustrates steps in transitioning between the methods shown separately in FIGS. 6 and 7. Steps which are the same as those in FIGS. 6 and 7 will not be explained in more detail.

After the control parameter has been optimised in step 144 of FIG. 8 and the new value of the control parameter distributed in step 146, a control parameter wait period in observed in step 148. At the end of the wait period, a radio environment map and/or a performance indicator map is created using the new control parameter.

In the exemplary combined method as shown in FIG. 8, in step 164 it is determined whether optimisation of the control parameter has improved the system performance. For example, the current performance indicators can be compared with the previous ones.

If the optimisation of the control parameter has improved the performance, step 164-y the improvement of the network using the optimisation of control parameters can be continued.

However, if the performance indicators for the updated control parameter do not meet the targets and they are not improved, the control parameter optimisation has not achieved an improvement in the network performance. In this case, since the optimisation carried out in step 144 previously has not resulting in an improvement in network performance, the method enters step 154 in which configuration parameters can be optimised.

In the exemplary embodiment shown in FIGS. 1 and 5, an optimisation notification 78 may be sent from the control parameter optimisation function 52 to the configuration parameter optimisation function 70 to indicate that the configuration parameter optimisation function 70 should carry out an optimisation of the configuration parameters.

After configuration parameter optimisation method steps 156-160 and 152 have been carried out as described above with reference to FIG. 7 in step 166 it is determined whether the optimisation of the configuration parameters has improved the radio environment and the performance indicator.

If the optimisation of the configuration parameters has not improved the radio environment and the performance indicator, step 166-n, the method returns to the previous configuration parameters in step 168.

Thereafter, the method returns to the method of optimising the control parameters of the network in the method set out in steps 142, 144, 146.

In the exemplary embodiment shown in FIGS. 1 and 3 an optimisation notification 62 may be sent from the configuration parameter optimisation function 70 to the control parameter optimisation function 52 to indicate that the control parameter optimisation function 52 should carry out an optimisation of the control parameters.

From the above description it is clear that embodiments of the invention can be used to adapt network coverage to daily traffic and radio environment changes in the network.

The method uses radio measurements implemented in the mobiles and the system, therefore drive tests are not needed and radio environment measurements are done exactly where the users are using the network.

Embodiments of the invention optimize the controlling parameters of advanced radio network management functions, in particular for radio network management functions that influence the coverage provided by the communication network.

In this way other automatic network functions running parallel in the network, such as channel switching, power control, load balancing, advanced coding schemes, multiple and multi-band antenna systems, active admission control, handover and capacity management do not interfere with each other or with the network management optimization.

Radio communication networks in which embodiments of the invention are implemented operate automatically in closed loop reducing manual work and human errors.

The method improves continuously the network performance. The performance data are correlated with positioning data, therefore, the method provides a detailed performance mapping of the network and indicates sub-cell level spots where the network should be improved or expanded.

1. An automatic method of service coverage management in a management node of a radio communication network for continually managing radio transmissions within the radio communication network, wherein the operation of the radio management function is determined by at least one control parameter, the method comprising the steps of:
analysing at least one of a radio environment measurement mapping or a performance indicator mapping of the radio communication network to determine a service coverage mapping of the radio communication network;
generating a new value for the at least one control parameter for the radio management function in order to optimise the service coverage of the radio communication network; and
distributing the new value for the at least one parameter for the respective radio management function in the network.

2. The method as claimed in claim 1, wherein the at least one control parameter is a control parameter for use by a radio management function in determining a radio parameter affecting radio transmissions within the radio communication network.

3. The method as claimed in claim 1, wherein the performance indicator mapping of the radio communication network is used in the step of analysing.

4. The method as claimed in claim 1, further comprising the steps of:
operating with the optimised control parameters for a control parameter wait period;
determining whether the new value of the at least one control parameter has improved the network coverage; and
in response to an improvement, confirming a trial value of the at least one control parameter as the corresponding control parameter for the radio communication network.

5. The method as claimed in claim 4, wherein the step of determining whether the new value of the at least one control parameter has improved the network coverage comprises the steps of:
comparing radio measurements in the radio communication network operating using the trial value for the at least one control parameter with prior radio measurements; and
comparing performance indicators in the radio communication network operating using the trial value for the at least one control parameter with prior performance indicators.

6. The method as claimed in claim 5, wherein the step of comparing radio measurements comprises the steps of:
forming a radio measurement mapping from received network radio measurements and position data associated with the radio measurements in the radio communication network operating using the trial value; and
comparing the radio measurement mapping with a prior radio measurement mapping.

7. The method as claimed in claim 5, wherein the step of comparing performance indicators comprises the steps of:
forming a performance indicator mapping from received performance indicators and position data associated with the performance indicators in a radio communication network operating using the trial value; and
comparing the performance indicator mapping with a prior performance indicator mapping.

8. The method as claimed in claim 4, wherein the control parameter wait period is in the range of a few minutes to an hour.

9. The method as claimed in claim 4, further comprising, in response to a negative determination in the step of determining, the step of requesting optimisation of at least one configuration parameter of the radio communication network.

10. The method as claimed in claim 1, wherein the step of analysing at least one of a radio environment measurement mapping or a performance indicator mapping of the radio communication network to determine a service coverage mapping of the radio communication network is carried out in response to the optimisation of at least one configuration parameter of the radio communication network.

11. The method as claimed in claim 9, wherein the at least one configuration parameter relates to one or more of: antenna height; antenna type; antenna direction; frequency band; and site location of base stations of the radio network.

12. A management node of a radio communication network for continually managing radio transmissions within the radio communication network, wherein the operation of the radio management function is determined by at least one control parameter, comprising:
a parameter optimisation function for analysing at least one of a radio environment measurement mapping or a performance indicator mapping of the radio communication network to determine a service coverage mapping of the radio communication network; and generating a new value for the at least one control parameter for the radio management function in order to optimise the service coverage of the radio communication network; and
a configuration service for distributing the new value for the at least one control parameter for the respective radio management function in the network.

13. The management node as claimed in claim 12, wherein the at least one control parameter is a control parameter for use by a radio management function in determining a radio parameter affecting radio transmissions within the radio communication network.

14. The management node as claimed in claim 12, wherein the parameter optimisation function includes:
a correlation function configured to receive position information and performance indicator measurements and to generate a performance indicator mapping of the radio communication network.

15. The management node as claimed in claim 14, further comprising a compare function, the compare function being configured to receive and compare the target performance indicator values and the performance indicator mapping of the radio communication network.

16. The management node as claimed in claim 14, wherein the correlation function is also configured to receive radio environment data and to generate a radio environment mapping of the radio communication network.

17. The management node as claimed in claim 16, further comprising a compare function, the compare function being configured to receive and compare the target radio environment value and the radio environment mapping of the radio communication network.

18. The management node as claimed in claim 14, further comprising a logic function configured to receive comparison information and operable to generate a new value for the at least one control parameter for the radio management function in order to optimise the service coverage of the radio communication network.

19. The management node as claimed in claim 18, further comprising a scheduler coupled to the parameter optimisation function and configured to initiate an optimisation process after the elapse of a control parameter wait period.

20. The management node as claimed in claim 19, wherein the control parameter wait period is in the range of a few minutes to an hour.
